(19) United States
(12) Patent Application Publication
(10) Pub. No.: US 2009/0187490 A1
(43) Pub. Date: Jul. 23, 2009

(54) SYSTEM AND A METHOD ENABLING A CUSTOMER AND A BUSINESS TO INTERCONNECT VIA INSTANT MESSAGING IN ORDER TO COMPLETE A BUSINESS TRANSACTION

(76) Inventor: Avi Tali-Levi, Tel Aviv (IL)

Correspondence Address: Naomi Assia Law Offices;C/O Landon IP Inc., Suite 450, 1700 Diagonal Road, Alexandria, VA, 22314, US

(21) Appl. No.: 12/018,227

(22) Filed: Jan. 23, 2008

(51) Int. Cl. G06Q 30/00

(52) U.S. Cl. 705/26

(57) ABSTRACT

A method to provide a service to enable a buyer and a seller to interconnect via real-time messaging to complete a successful business transaction. The method includes registering by the buyer and customizing a profile by the buyer. The method also includes registering, paying a subscription and customizing a profile by the seller businesses. The system receives the buyer's inputs and the sellers' profiles. The buyer logs in and specifies an acquisition request. The system matches the buyer's acquisition request with relevant seller businesses and sends a list of the relevant seller businesses to the buyer that accommodate his acquisition request. He decides whether to purchase, designates a seller business, makes the purchase online and the seller pays a commission.

### FIELD OF THE INVENTION

The present invention relates generally to e-commerce transactions, and more particularly relates to wired and wireless e-commerce transactions utilizing internet instant messaging infrastructure as a platform for personalized commercial businesses.

### BACKGROUND OF INVENTION

By now e-commerce is a well accepted form of doing business, every year we witness a growing share of the world's overall commercial transaction volume. However, there is no platform which provides immediate, personalized and suited profile based solution for the customer's needs.

In addition, there is no immediate way for the business to reach and influence its potential customers. The current available methods which are being used to expand the customer base are spam (“junk” mail), direct mail (to your home mailbox) and advertisements. Those methods are scattered, inflexible, frustrate the customer and irrelevant at delivery time.

Instant messaging is a type of communications service that enables one to create a kind of private chat room with another individual or individual in an organization in order to communicate in real time over the Internet. The communication is analogous to a telephone conversation but uses text-based, not voice-based, communication. Typically, the instant messaging system alerts the user whenever somebody on his private list is online. One can then initiate a chat session with that particular individual.

According to Wikipedia, Extensible Messaging and Presence Protocol (XMPP) is an open, XML-inspired protocol for near-real-time, extensible instant messaging (IM) and presence information (a.k.a. buddy lists). It is the core protocol of the Jabber Instant Messaging and Presence technology. The protocol is built to be extensible and other features such as Voice over IP and file transfer signaling have been added.

Unlike most instant messaging protocols, XMPP is based on open standards. Like e-mail, it is an open system where anyone who has a domain name and a suitable Internet connection can run their own Jabber server and talk to users on other servers. The standard server implementations and many clients are also free and open source software.

### Features

### Decentralization

The architecture of the XMPP network is similar to email; anyone can run their own XMPP server and there is no central master server.

### Decentralization and Addressing

The Jabber network is server-based (i.e. clients do not talk directly to one another) but decentralized; by design there is no central authoritative server, as there is with services such as AOL Instant Messenger or MSN Messenger. Some confusion often arises on this point as there is a public XMPP server being run at “Jabber.org”, to which a large number of users subscribe. However, anyone may run their own XMPP server on their own domain.

Since a user may wish to log in from multiple locations, the server allows the client to specify a further string known as a resource, which identifies which of the user's clients it is (for example home, work and mobile). This may then be included in the JID by adding a forward slash followed by the name of the resource. Each resource may have specified a numerical value called priority. For example the full JID of a user's mobile account would be username@domain.com/mobile. Messages that are simply sent to username@domain.com will go to client with highest priority, but those sent to username@domain.com/mobile will only go to the mobile client.

### Message Delivery Process

Suppose juliet@capulet.com wants to chat with romeo@montague.net. Juliet and Romeo each respectively have accounts on the capulet.com and montague.net servers. When Juliet types in and sends her message, a sequence of events is set in action:

1. Juliet's client sends her message to the capulet.com server
If montague.net is blocked on capulet.com the message is dropped.
   2. The capulet.com server opens a connection to the montague.net server.
   3. The montague.net server delivers the message to Romeo

If capulet.com is blocked on montague.net, the message is dropped.

If Romeo is not currently connected, the message is stored for later delivery.

### Connecting to Other Protocols

Another useful feature of the XMPP system is that of transports, also known as gateways, which allow users to access networks using other protocols. This can be other instant messaging protocols, but also protocols such as SMS or E-mail. Unlike multi-protocol clients, XMPP provides this access at the server level by communicating via special gateway services running on a remote computer. Any user can “register” with one of these gateways by providing the information needed to log on to that network, and can then communicate with users of that network as though they were Jabber users. This means that any client which fully supports XMPP can be used to access any network to which a gateway exists, without the need for any extra code in the client and without the need for the client to have direct access to the Internet. This may violate terms of service on the protocol used; however, such terms of service are not legally enforceable in several countries.

### XMPP and HTTP

Another aspect of XMPP is the HTTP binding for users behind restricted firewalls. In the original specification, XMPP could use HTTP in two ways: polling and binding. Polling is now deprecated, but HTTP polling essentially implies messages stored on a server-side database are being fetched (and posted) regularly by an XMPP client by way of HTTP ‘GET’ and ‘POST’ requests. With binding, the client uses longer-lived HTTP connections to receive messages as soon as they are sent. This push-model of notification is more efficient than polling, where many of the polls return no new data.

Because the client uses HTTP, most firewalls would allow the client to fetch and post messages without any hindrance. Thus, in scenarios where the TCP port used by XMPP is blocked, a server can listen on the normal HTTP port and the traffic should pass without problems. There also are various websites which allow people to sign in to Jabber via their browser.

### Uptake and Clients

XMPP is implemented by a large number of XMPP clients, servers, and code libraries. These include:
Google Talk, Google's instant messaging product, uses an implementation of the protocol.
LJTalk, Livejournal's instant messaging product, also uses XMPP, running the perl-based implementation, DJabberd
The Gizmo Project, primarily a Voice over IP system using Session Initiation Protocol (SIP), uses XMPP as its instant messaging protocol and can interoperate with Google Talk for text.
The free and open source peer-to-peer WiredReach Universal Content Sharing System, an example of social networking software, depends upon XMPP.
Pidgin, formerly named Gaim. A GPL licensed multi-protocol, multi-platform client.
Kopete, another GPL licensed multi-protocol, multi-platform client for KDE.
Miranda_IM, freeware, opensource client with multi-protocol support.

In US Pat. Applic. No. 20070150588, Ghadialy, et al., disclose an Apparatus and Method for Providing a Marketing Service. In one embodiment, a computer-readable storage medium includes: (1) a preferences module that is configured to collect a set of preferences of a user; (2) a monitoring module that is configured to monitor a web site based on the set of preferences so as to identify relevant content; and (3) a notification module that is configured to generate a message alerting the user of the relevant content.

Thus, it would be advantageous, if small businesses could benefit from the millions of potential online shoppers, such that buyers and sellers could interconnect via instant, i.e., instant messaging to complete a successful and mutually beneficial business transaction, where the buyer is given the information to make an optimum choice among the most relevant and convenient sellers.

### SUMMARY OF THE INVENTION

Accordingly, it is a principal object of the present invention to provide a global business platform, which allows buyer and seller to interconnect via instant messaging to complete a successful business transaction.

It is another principal object of the present invention to provide a system and a method for wired e-commerce transactions utilizing Internet instant messaging infrastructure as a platform for personalized commercial businesses.

It is one other principal object of the present invention to provide a system and a method for wireless e-commerce transactions utilizing Internet instant messaging infrastructure as a platform for personalized commercial businesses.

A method to provide a service to enable a buyer and a seller to interconnect via real-time messaging to complete a successful business transaction. The method includes registering by the buyer and customizing a profile by the buyer. The method also includes registering, paying a subscription and customizing a profile by the seller businesses. The system receives the buyer's inputs and the sellers' profiles. The buyer logs in and specifies an acquisition request. The system matches the buyer's acquisition request with relevant seller businesses and sends a list of the relevant seller businesses to the buyer that accommodate his acquisition request. He decides whether to purchase, designates a seller business, makes the purchase online and the seller pays a commission.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1a is a system block diagram of an exemplary system for a method enabling a consumer/customer/buyer and a business/seller to interconnect via instant messaging in order to complete a business transaction, constructed according to principles of the present invention;

FIG. 1b is a system block diagram of a model of a method enabling a customer and a business to interconnect via instant messaging in order to complete a business transaction, constructed according to principles of the present invention;

FIG. 2 is a flow chart illustration of a model of a method enabling a customer and a business to interconnect via instant messaging in order to complete a business transaction, constructed according to principles of the present invention; and

FIG. 3 is a flow chart illustration of the order confirmation process, constructed according to principles of the present invention;

### DETAILED DESCRIPTION OF THE INVENTION

The invention is a business platform which enables the customer (consumer) and the business to perform a business transaction VIA instant messaging. The connection between the business and the customer is based on an instant messaging platform provided by the application.

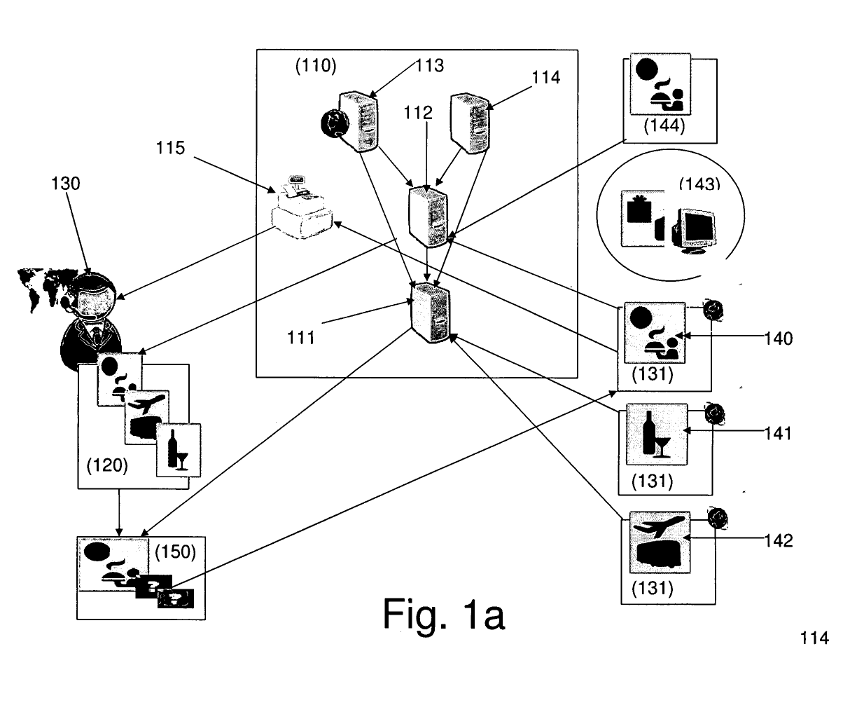

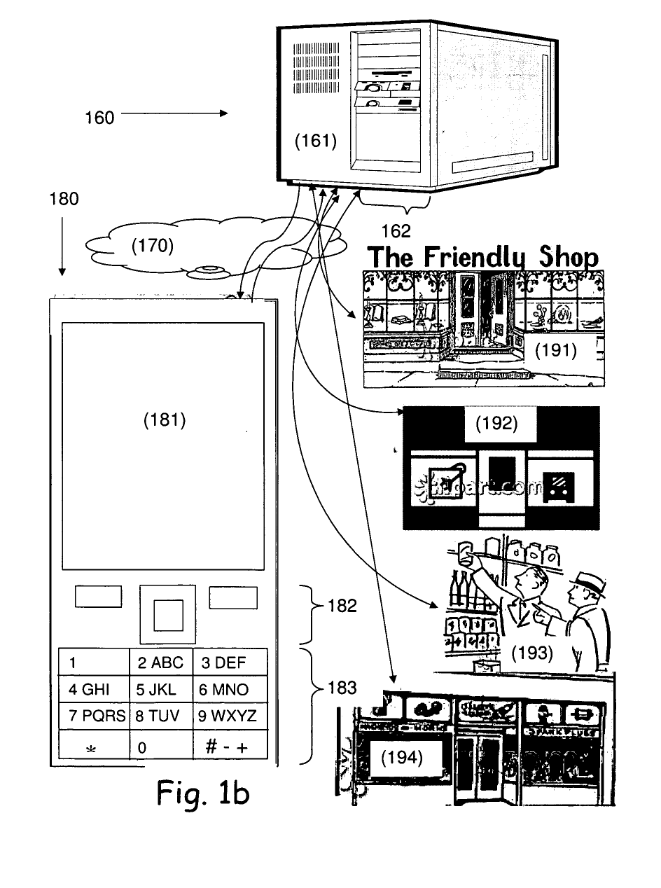

FIG. 1a is a system block diagram of an exemplary system 110 for a method enabling a consumer/customer/buyer and a business/seller to interconnect via instant messaging in order to complete a business transaction, constructed according to principles of the present invention. System 110 includes an E-commerce infrastructure 160 which includes
111. a web server, comprise a http server, a Java application server
112. an XMPP based instant messaging server (IMS)
113. A Geographical information system
114. Databases to hold all, customer, business, transactions, and transactions history
115. a defrayal system or a defrayal mechanism of any sort
130. an end user with any end user device connected via a custom Instant messaging client directly to the IMS
131. any end user device connected via a HTTP interface to the IMS through a portal, embedded code, or affiliated websites
120. Customer client, acts through the Internet to match, at any given time, only the most relevant businesses 140, 141, 142 based on location and availability filtering out logged off businesses 143, and businesses not serving customer location 144, with the addition of user custom filters and display them through a menu driven sorted list.
150. customer customize order through a predefined wizard sending the order as an instant message to selected business/seller.
Payment is completed through the defrayal system 115.

FIG. 1b is a system block diagram of a model of a method enabling a consumer/customer/buyer and a business/seller to interconnect via instant messaging in order to complete a business transaction, constructed according to principles of the present invention. A Web server 160, preferably residing at an entrepreneurial Web site, preferably comprise a Java application console 162 and a database 161 of registered business and registered consumers with the corresponding profiles of the consumers.

Mobile phone 180 or any other end-user device, such as a personal computer, laptop, etc., is used by a consumer/buyer to make a request concerning a purchase he is considering making. The Instant Messaging System acts through the Internet 170 to match the buyer's request, according to his profile with a list of businesses 191, 192, 193 and 194, most appropriate to fulfill the request. Exemplary mobile phone 180 includes a touch screen display area 181, some navigation buttons 182 and a keypad 183 to enter numbers and letters, etc.

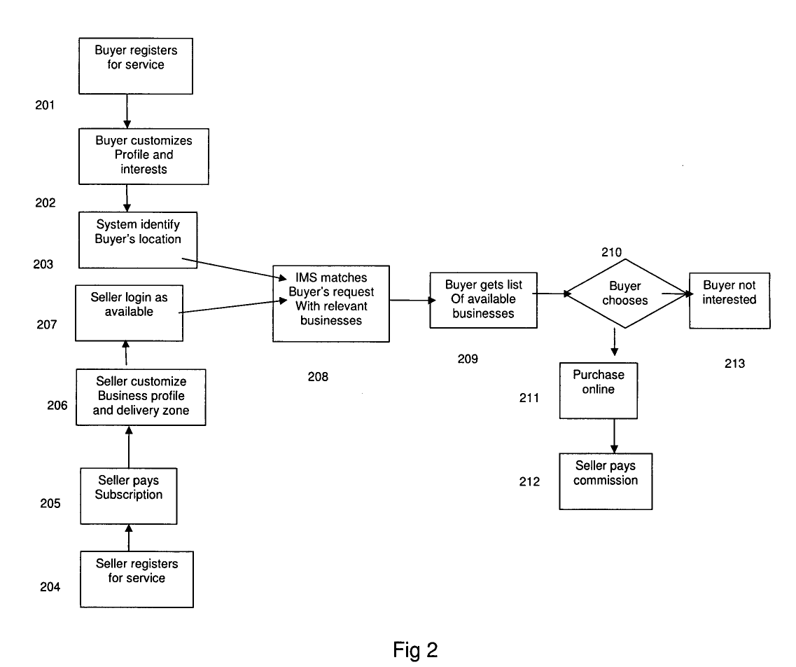

FIG. 2 is a flow chart illustration of a model of a method enabling a customer and a business to interconnect via instant messaging in order to complete a business transaction, constructed according to principles of the present invention. A buyer registers for the service 201 and then customizes his profile and acquisition interests 202. The system then identifies the buyer's location 203.

The seller also registers for the service 204, pays a subscription 205 and customizes his profile, including his delivery zone 206. The seller logs in if a login is available 207. The Instant Messaging System receives the buyers' inputs 202 and the sellers' inputs 206 and matches each buyer's acquisition interest with relevant seller businesses 208. The buyer gets a list of businesses that accommodate his acquisition interests 209. The buyer decides whether to purchase and designates a seller from the listed businesses 210.

If the buyer decides not to purchase, the scenario ends 213. If the buyer decides to purchase, the purchase is made online 211 and the designated seller pays a commission 212.

The main procedures of the present invention:

1. Registering and creating a new client profile (both buyers and businesses).
2. Dynamic profile and supply changes.
3. Real-time promotions.
4. Searching the database and presenting only relevant results.
5. Performing a business transaction.

Registering and Creating a New Client Profile

Each user can register as either as a customer or a business; and

The registration process creates a user profile; and

The user profile will be the basis for all future logins, searches, transaction etc.

Table I-A shows details of the buyer sign-on process:

TABLE I-A
Buyer Sign-on process

Download
Run installation
Register interests
Location/s
Preferred services.
Preferred search categories.
Provide contact information
Name, phone
Contact information
Provide payment information
Credit card, pay pal
Provide optional basic demographic
information
Age, gender etc.

Table I-B shows details of the immediate buy process:

TABLE I-B
Immediate buy process

Choose business to buy from
Category, sub-category, descriptors
Choose from available businesses
Select specific item/s to buy
Customize details
Fill in shipping address
Buyer Confirmation
Choose predefined payment method from
profile.
Business confirmation
Message is sent to the business (IM/SMS).
Business confirm/deny deal.
Confirm payment method
Confirmation/denial is sent to buyer

Table II-A shows the seller sign-on process:

TABLE II-A
Seller Sign-on process

Download
Run installation
Register business details
Contact information.
Location/s
Available services/Categories
Delivery areas
Menus
Provide business accounting information.

Table II-B shows the seller instant promotions process:

TABLE II-B
Seller Instant promotions process

Seller chooses the product/s to be on promotion.
Seller chooses the method of promotion:
Quantity discount.
Combination discount.
Regular discount.
Limited to first X buyers.
Set time limit for the promotion.
Confirm the promotion.
Every connected user within the delivery area will
get a promotion notice.
Notice is a message in the promotions tab.

### Dynamic Profile and Supply Changes

The strongest feature of the invention is the ability of the business and the buyer to change there profile and supply dynamically. The buyer can change his location, payment details and preferences in order to enjoy the service all over the world. The business can change most of its parameters so it can dynamically adjust itself to what is happening in the business at the current time, expand/reduce supply area, change the menu, increase/decrease supply time, prices, etc.

Table III-A shows the dynamic buyer profile change:

TABLE III-A
Dynamic buyer profile change

Viewing your current profile information
Choose the category to be changed
Change the relevant buyer category
Submit the changes to the server

Table II-B shows the dynamic seller profile change:

TABLE III-B
Dynamic seller profile change

Viewing your current profile information
Choose the category to be changed
Menus
Prices
Sales
Announcements
Delivery area
Change the relevant seller category
Submit the changes to the server

### Real-Time Promotions

This feature allows the business to create the best promotions for the business at the best time for the business while reaching the relevant buyers, all in real-time.

### Searching the Database and Presenting Only Relevant Results

The searches that are performed on the system will present only the relevant search results.

What is a relevant result?

1. Businesses that supply to the buyer's address.
2. Only open businesses.
3. price range as specified by the buyer

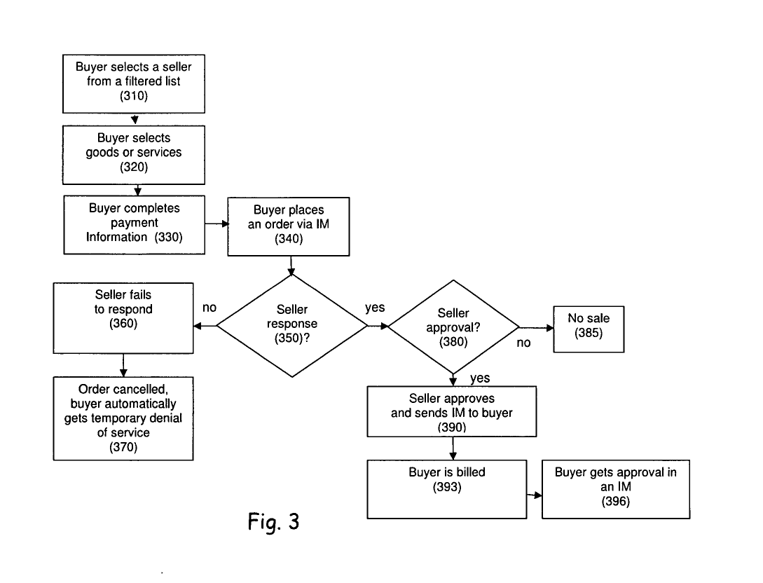

FIG. 3 is a flow chart illustration of the order confirmation process, constructed according to principles of the present invention. The buyer selects a seller from a filtered list 310. The buyer selects goods and or services 320. The buyer submits payment information 330 and places an order and an Instant Message is sent with the order details 340. The seller may respond 350. If the seller fails to respond 360, the order is cancelled and the buyer automatically gets a notice of temporary denial of service 370. If there is a seller response, the seller decides whether to approve of the order 380. If the seller disapproves there is no sale 385. If the seller approves, he sends an approval IM to the buyer 390, the buyer is billed 393 and the buyer receives the approval in an IM 396.

### Performing a Business Transaction

The application connects between the buyers and the businesses. The buyer places an order, the business approves the transaction, the payment is approved and only then the business transaction ends.

### The Available Features for the Buyer:

1. Large businesses database.
2. Reaching only the relevant businesses.
3. Filtering the irrelevant businesses.
4. Establishing a connection with the chosen business.
5. A presentation on the business's offerings.

### The Available Features for the Business:

1. Large customers' database.
2. Approaching only the relevant buyers.
3. Real-time promotions.
4. Dynamic changes of most of the business parameters.
5. Establishing a connection with a buyer.

### 6. Defrayment.

7. Reports and statistics.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method to provide a service by a system to enable a buyer and one of a plurality of seller businesses to interconnect via instant messaging to complete a successful business transaction, the method comprising:
registering by the buyer for the service;
customizing by the buyer of his inputs comprising a profile and interests;
registering by the seller businesses for the service;
paying a subscription and customizing his profile by each of said plurality of seller businesses;
receiving by the system of the buyer's inputs and the sellers' profiles;
logging in by the buyer and specifying an acquisition request;
matching said buyer's acquisition request with relevant seller businesses among the plurality of seller businesses;
sending a list of said relevant seller businesses to the buyer that accommodate his acquisition request;
deciding by the buyer whether to purchase and if so designating a seller business from among said relevant listed businesses;
making said purchase online; and
paying a commission by said designated seller business.

2. The method according to claim 1, wherein said profile comprises at least one of location, preferred items, interests, services and credit card details.

3. The method according to claim 1, wherein said profile is kept in the system and is used each time the buyer logs in.

4. The method according to claim 1, wherein said logging in is performed by using a Java application console.

5. The method according to claim 1, wherein said matching is performed by an Instant Messaging System (IMS).

6. The method according to claim 5, wherein said matching is performed according to at least one of the buyer's location, the buyer's overall profile and currently available services of each of said plurality of sellers.

7. The method according to claim 1, wherein said paying further comprises one of approving and disapproving of said payment by a financial institution serving said buyer.

8. The method according to claim 7, wherein said disapproving further comprises sending a cancellation order by said financial institution to said buyer said buyer.

9. The method according to claim 8, wherein said sending further comprises providing an option to said buyer to use another payment method.

10. The method according to claim 1, wherein said profile by each of said plurality of seller businesses comprises at least menus, delivery areas, sales and announcements.

11. The method according to claim 1, further comprising changing parameters periodically by each of said plurality of businesses.

12. The method according to claim 11, wherein said changing parameters comprises adjusting to the current business environment.

13. The method according to claim 12, wherein said adjusting comprise at least one of expanding supply area, reducing supply area, changing the menu, increasing supply time decreasing supply time and adjusting prices.

14. The method according to claim 1, wherein said specifying an acquisition request is made by the buyer using a mobile phone.

15. A system to provide a service between a buyer and one of a plurality of seller businesses to interconnect via instant messaging to complete a successful business transaction, the system comprising:
Registering means for the buyer for the service;
customizing means for by the buyer for his inputs comprising a profile and interests;
registering means for the seller businesses for the service;
paying means for a subscription and customizing his profile by each of said plurality of seller businesses;
receiving means for the system of the buyer's inputs and the sellers' profiles;
logging means for the buyer and specifying means for an acquisition request;
matching means of said buyer's acquisition request with relevant seller businesses among the plurality of seller businesses;
sending means for a list of said relevant seller businesses to the buyer that accommodate his acquisition request;
deciding and entering means for the buyer of whether to purchase and if so designating means of a seller business from among said relevant listed businesses;
means for making said purchase online; and
means for paying a commission by said designated seller business.
